(19) United States
(12) Patent Application Publication
(10) Pub. No.: US 2022/0235431 A1
(43) Pub. Date: Jul. 28, 2022

(54) SORPTION APPARATUS

(71) Applicant: Obshchestvo s Ogranichennoy Otvetstvennostyu"Obedinennaya Kompaniya Rusal Inzhenerno-Tekhnologichesk, KRASNOYARSK (RU)

(72) Inventors: Aleksandr Borisovich Kozyrev, KRASNOYARSK (RU); Ol'ga Viktorovna Petrakova, KRASNOYARSK (RU); Sergej Nikolaevich Gorbachev, KRASNOYARSK (RU)

(21) Appl. No.: 17/720,269

(22) Filed: Apr. 13, 2022

Related U.S. Application Data
(63) Continuation of application No. PCT/RU2020/050203, filed on Aug. 26, 2020.

(30) Foreign Application Priority Data
Oct. 14, 2019 (RU) 2019132281

(51) Int. Cl. C22B 3/24; B01D 15/02; C22B 3/02

(52) U.S. Cl. CPC C22B 3/24; C22B 3/02; B01D 15/02

(57) ABSTRACT

The sorption unit/apparatus contains a body, an airlift, a circulator, a disperser, slurry or solution and sorbent supply and discharge pipes, a catchment located below the slurry level. At that, the catchment is made in the form of an immersed draining device with a tapered bottom and a drain pipe ensuring evacuation by gravity of slurry or solution from the sorption unit, the disperser is made in the form of a perforated pipe, on the outer surface of which elastic elements are located inside the circulator and it is connected to a pipe for the supply of compressed air. The proposed design of the sorption unit allows for carrying out continuous sorption from solutions and slurries thereby increasing the reliability of the sorption unit, simplifying its maintenance, reducing operating costs by reducing the loss of expensive sorbent.

### CROSS-REFERENCE TO RELATED APPLICATIONS

This application is a continuation of and claims priority to PCT Application No. PCT/RU2020/050203 filed Aug. 26, 2020, which itself claims priority to Russian Patent Application No. 2019132281 filed Oct. 14, 2019 which is incorporated herein by reference in its entirety for all purposes.

### TECHNICAL FIELD

This disclosure relates to devices for sorption extraction of useful components from solutions and slurries (sorption leaching) and can be used in hydrometallurgy of rare, non-ferrous and precious metals.

### BACKGROUND

Sorption units are known representing a kind of mixer-settler units of Pachuk type, which are vertical devices equipped with one or more airlifts that serve to mix resin and solution (slurry), to unload resin and to pump the resin-solution or resin-slurry flow to catchments, from which resin returns to the sorption unit, while solution (slurry) moves further along the process line [Ryabchikov B. E., Zakharov E. I. Ion Exchange Equipment/M.: Tsniitsvetmetinformatsiya Central Scientific Research Institute, 1974, pp. 23-25]. The disadvantage of these sorption units consists in an uneven distribution of slurry along the catchment grids, to which the resin is pumped, and significant wear of expensive sorbents due to their mechanical destruction when colliding with the catchment grids resulting in an increase in operating costs.

A sorption unit is also known, including a body, a catchment unit, slurry and ionite supply and discharge pipes, an airlift transport pipe made with openings located below the level of the slurry and ionite mixture, a compressed air supply pipe with holes in the air dispersion zone. The presence of openings in the airlift transport pipe makes it possible to achieve self-regulation of the level of the slurry and ionite mixture in the sorption unit, and, consequently, stabilisation of the working level of slurry with a constant flow of compressed air (SU 1169240, publication date: Mar. 23, 1986). The disadvantage of this sorption unit is the design of the air dispersion device representing a pipe with holes that may be clogged with slurry, which will lead to a decrease in the performance of the sorption unit. Another disadvantage of this sorption unit is its catchment unit consisting of grids on which slurry is fed for its separation into ionite and solution (slurry), which leads to an increase in sorbent consumption due to its abrasion and an increase in the costs for adding sorbent.

The closest to the proposed technology in terms of the technical essence and the achieved result, chosen as a prototype, is a sorption unit according to SU 1187870, publication date: Oct. 30, 1985, containing a cylindrical body with an airlift, a circulator and a disperser located in it, slurry and ionite supply and discharge pipes, a catchment unit located above the slurry level and additional catchments located below the slurry level and trolleys connected to them, installed with the possibility of movement. Additional catchment units located below the slurry level allow to reduce the consumption of compressed air due to the fact that the main flow of slurry is diverted by gravity through them, and not by slurry forced circulation through the upper catchment unit. The disadvantage of the known sorption unit is the presence of external mixing occupying the entire working volume of the sorption unit, which can lead to a decrease in the performance of the catchment units as a result of slurry adhesion to the catchment grids. Besides, the presence of a draining unit located above the slurry level, to which part of slurry is fed by an airlift, contributes to greater wear of sorbent than when separating slurry using the draining devices located below the slurry level.

### BRIEF DESCRIPTION OF THE DRAWINGS

FIG. 1 shows an exemplary layout of the sorption unit.

FIG. 2 shows an exemplary disperser used in association with the sorption unit.

### DETAILED DESCRIPTION

The objective of the proposed technology is to increase the reliability of the sorption unit in periodic and continuous operational modes and reduce operating costs.

The technical result consists in preventing a decrease in the throughput of the draining devices and disperser over time due to their clogging with slurry, as well as in reducing the mechanical abrasion of the sorbent when the sorbent collides with the draining device of the sorption unit and, as a result, in reducing the consumption of the sorbent and improving operational characteristics.

The assigned task is solved, and the technical result is achieved due to the fact that in the sorption unit containing a cylindrical body, an airlift, a circulator installed in the central part of its body, a disperser, slurry or solution and sorbent supply and discharge pipes, a catchment located below the slurry level, according to the claimed subject-matter, the catchment is made in the form of an immersed cylindrical device, with a conical bottom and a cylindrical cover, in the side surface of which a drain pipe is inbuilt, made with the possibility of removing by gravity the solution or slurry from the sorption unit, the disperser is made in the form of a perforated pipe, on the outer surface of which elastic elements are placed close to each other, the disperser is fixed inside the circulator and connected to the compressed air supply pipe.

The elastic elements may be made, in particular, of rubber, thermoplastic or polyurethane elastomers.

To ensure control over the concentration of sorbent in the working volume of the sorption unit in order to achieve optimal technological indicators of the sorption process, such as the ionite (sorbent) sorption capacity in terms of the target component, sorption spent liquor composition, the sorption unit contains on its cover an additional device for monitoring the concentration of sorbent in the working volume, made in the form of a container installed in the upper part of the body, and equipped with a measuring cylinder, shut-off valves and an airlift for feeding a mixture of slurry or solution and sorbent.

By means of an airlift placed in the working volume of the unit, a mixture of solution (slurry) and sorbent is pumped, after the air supply to the airlift is stopped, the sorbent settles in the lower part of the measuring cylinder, its volume is measured and the concentration of the sorbent in the working volume of the sorption unit is calculated. The concentration of the sorbent in the working volume of the sorption unit is regulated by increasing or decreasing the flow of compressed air supplied to the solution (slurry) circulation system. This sorption unit allows for the most complete use of the sorbent exchange capacity, which allows saving the sorbent used in the processes of sorption recovery of valuable components from solutions and slurries.

To maintain the reaction temperature at the stage of sorption recovery from the solution or slurry, a coil is installed in the central part of the working volume of the sorption unit, into which a thermal medium is fed.

To restart the sorption unit after an emergency and a planned shutdown, a disperser is additionally installed on the bottom of the unit representing a system of plates that allow compressed air to be introduced into slurry through a pipeline attached to the bottom of the unit, and at the same time to prevent penetration of slurry into this pipeline.

Prevention of a decrease in the throughput of draining devices ensuring the separation of ionite and slurry (solution) is achieved through the use of an immersed cylindrical draining device, in which there is no external mixing—no slurry mixing in the entire working volume of the draining device, including near the mesh surface of the drain pipe through which the solution or slurry are removed after sorption. In the claimed subject-matter, the mesh surface of the drain pipe is located inside the cylindrical body of the immersed draining device representing a sump where the mixture of slurry and sorbent stops moving, as if ‘calms down,’ and the liquid saturated with sorbent valuable components is separated (by entering the working volume of the sorption unit through the lower part of the immersed draining device, then by settling on the bottom of the sorption unit and being pumped out of it by an airlift) from the slurry or solution (which are discharged through the mesh surface of the drain pipe). In the prototype, catchments located below the slurry level are washed by slurry continuously.

Thus, the design of the immersed draining device of the sorption unit allows to exclude a strong collision of the sorbent and slurry with the mesh surface of the drain pipe and to reduce the mechanical destruction of the sorbent, as well as slurry adhesion to the mesh surface of the drain pipe. At the same time, the disperser made in the form of a perforated pipe, on the outer surface of which elastic elements are placed close to each other, ensures the production of fine air bubbles and their uniform distribution in the working volume of the sorption unit, which ensures the uniform concentration of sorbent in the entire working volume of the sorption unit, and also prevents clogging of the openings of the disperser with slurry as well as prevents slurry penetration in the air supply pipeline.

The design of the sorption unit allows for carrying out the sorption process both in a continuous and periodic mode in a suspended layer of an ion-exchange sorbent (ionite). The design of the developed sorption unit allows for its simple maintenance and makes it easy to automate the slurry or solution treatment process and allows to use the sorption unit as an individual sorption device and as part of a cascade of sorption devices.

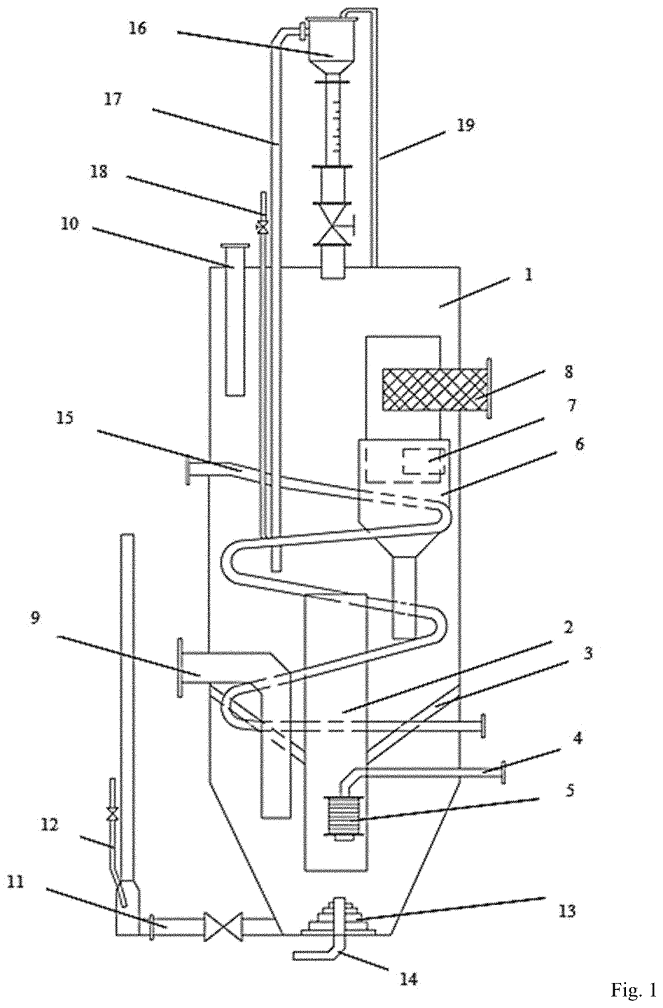

The sorption unit of FIG. 1 includes a cylindrical body 1 with a conical bottom and a cover, a circulator 2 (circulation pipe) fixed inside the sorption unit body by means of supports 3, a pipe 4 intended for supplying compressed air to a disperser 5 located inside the circulator 2, an immersed draining device 6 made in the form of a cylinder with a conical bottom and a cylindrical cover designed to separate the flow of solution (or slurry) and the sorbent, and fixed in the upper part of the sorption unit by means of plates 7, a drain pipe 8 inbuilt perpendicular in the cylindrical surface of the cover of the immersed drain device 6, through which the solution (slurry) is removed from the immersed draining device, a solution (slurry) injecting pipe 9, a sorbent injecting pipe 10, an airlift for pumping the sorbent 11 from the settling zone of the sorption unit, a pipe 12 meant for supplying compressed air to it, a disperser 13 intended for starting the sorption unit after an emergency shutdown and a pipe 14 meant for supplying compressed air to it, a coil 15 used for maintaining the temperature in the working area of the sorption unit, a sorbent concentration monitoring device 16 used to monitor the sorbent concentration in the working area of the sorption unit, made in the form of a container equipped in its lower part with a measuring cylinder and shut-off valves with an airlift used for feeding a mixture of slurry with a sorbent or a sorbent with a solution 17 from the working area, a pipe 18 used for supplying compressed air to the airlift and an air vent 19 designed for removing excess air supplied to the airlift into the working volume of the sorption unit.

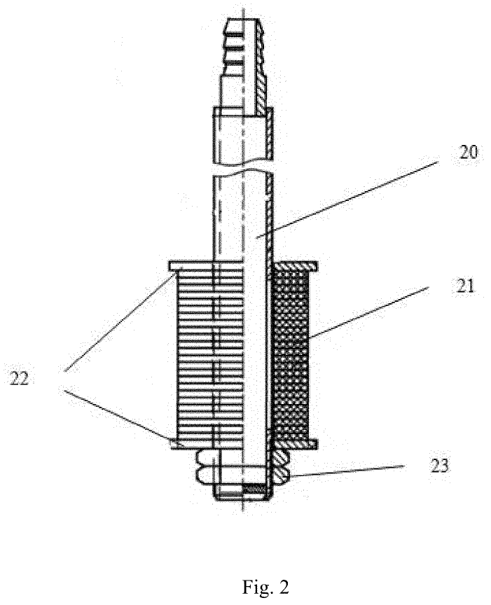

The disperser 5 shown in FIG. 2 contains a perforated pipe 20, on the outer surface of which elastic elements 21 are installed close to each other and fixed by means of washers 22 and nuts 23.

The principle of operation of the sorption unit is as follows.

Solution or slurry is fed into a cylindrical body of the sorption unit 1 through a pipe 9 located in the lower part of the apparatus body, sorbent (ionite) is fed through a pipe 10 fixed in the upper part of the apparatus body. Compressed air is fed through a pipe 4 to a disperser 5, which produces finely dispersed homogeneous air bubbles supplied to a circulator 2, in which solution (slurry) is mixed with sorbent (ionite), and the circulation of slurry throughout the working volume of the sorption unit is ensured by the movement of the mixture upward and from the centre to the periphery. The resulting slurry stays for a calculated time in the working volume of the sorption unit, then the flows of the solution (or slurry) and the sorbent are separated in the immersed draining device 6, from which the solution (or slurry) is removed through the drain pipe 8 from the sorption unit, while the sorbent through the lower part of the immersed draining device 6 gets back into the working area of the sorption unit. The sorbent saturated with a valuable component is deposited on the bottom of the sorption unit and pumped to the next sorption unit for regeneration using a sorbent pumping airlift 11 by supplying compressed air to it through a pipe 12, if the sorption unit is used as an individual sorption device, or to the next sorption device when implementing a sorption concentration unit in the form of a cascade of sorption devices. To ensure control over the concentration of sorbent in the working volume of the sorption unit, a device 16 is installed on its cover, into which through an airlift supplying a mixture of sorbent and solution (slurry) 17 and installed inside the sorption unit, a mixture of solution (slurry) and sorbent is pumped, after air supply to the airlift 17 is stopped, sorbent settles in the lower part of the measuring cylinder of the device 16, its volume is measured and the concentration of the sorbent in the working volume of the sorption unit is calculated. The concentration of the sorbent in the working volume of the unit is regulated by increasing or decreasing the flow of compressed air supplied through the disperser 5 to the circulator 2, in which the circulation of solution (slurry) is created by supplying compressed air through the pipe 4 to the disperser 5. To maintain the temperature of the medium, a coil 15 is installed in the central part of the working volume of the unit, into which a thermal medium (water or steam) is supplied. An additional disperser 13 is installed on the bottom of the unit to ensure the start of the sorption unit after an emergency or planned shutdown, made in the form of several plates of elastic material placed on a pipeline attached to the bottom of the sorption unit, through which compressed air is introduced into the slurry that has been precipitated on the bottom, thereby lifting it into the working area of the sorption unit. The disperser plates have a cylindrical shape, they may have a base of the same diameter or of different diameters, in the latter instance, plates with a larger diameter are located at the bottom, and plates with a smaller diameter are located on the top.

Taking into account the features and advantages of the disclosed technology, the scope of legal protection is sought in the form of the following set of essential features of this disclosure:

1. The sorption unit containing a body, an airlift, a circulator, a disperser, slurry or solution and sorbent supply and discharge pipes, a catchment located below the slurry level, characterised in that the catchment is made in the form of an immersed draining device with a tapered bottom and a drain pipe ensuring evacuation by gravity of slurry or solution from the sorption unit, the disperser is made in the form of a perforated pipe, on the outer surface of which elastic elements are located inside the circulator and it is connected to a pipe for the supply of compressed air.

2. The sorption unit according to claim 1, characterised in that the elastic elements are made, in particular, of rubber, thermoplastic or polyurethane elastomers, and are installed close to each other.

3. The sorption unit according to claim 1, characterised in that the drain pipe is inbuilt in the side surface of the cover of the immersed draining device.

4. The sorption unit according to claim 1, characterised in that it additionally contains a device for monitoring the concentration of the sorbent in the working volume, made in the form of a container installed in the upper part of the body, and equipped with a measuring cylinder, shut-off valves and an airlift for supplying slurry or solution, as well as sorbent from the working area of the unit.

5. The sorption unit according to claim 1, characterised in that a coil filled with a thermal medium is installed in the central part of the body, which serves to maintain the reaction temperature at the stage of sorption recovery from the solution or slurry to the central part of the working volume of the unit, while the circulator is also located in the central part of the body.

6. The sorption unit according to claim 5, characterised in that water or water vapour is used as the thermal agent.

7. The sorption unit according to claim 1, characterised in that an additional disperser is installed at the bottom of the body, which is able to restart of the device in case of its stop.

8. The sorption unit according to claim 1, characterised in that it contains a cylindrical body and an immersed cylindrical draining device, the bottom of which is made conical.

9. The sorption unit according to any of claims 1-8, characterised in that the design of the disperser ensures the production of fine air bubbles and their uniform distribution in the working volume of the unit, which leads to one and the same concentration of the sorbent in the entire working volume of the sorption unit, and also prevents the holes of the disperser from clogging with slurry or solution and prevents slurry or solution from entering the compressed air supply pipeline connected to the compressed air supply pipe.

10. The sorption unit according to any of claims 1-8, characterised in that the design of the immersed draining device makes it possible to exclude a strong collision of the sorbent and slurry with the surface of the drain pipe and to reduce the mechanical destruction of the sorbent, as well as the sticking of slurry or solution on the surface of the drain pipe.

11. The sorption unit according to any of claims 1-8, characterised in that ionite is used as the sorbent, for example, ion-exchange resin, an inorganic ion-exchange sorbent, or activated carbon.

12. The sorption unit according to claim 1, wherein both compressed air and a mixture of compressed air with other gases can be supplied to the disperser located inside the circulator, providing an intensification of the sorption process, depending on the characteristics of a particular technology, in particular, carbon dioxide, sulphur dioxide, ammonia, hydrogen sulphide.

The proposed design of the sorption unit allows for carrying out continuous sorption from solutions and slurries thereby increasing the reliability of the unit, simplifying its maintenance, reducing operating costs by reducing the loss of expensive sorbent.

What is claimed is:

1. A sorption unit comprising:
a body,
an airlift,
a circulator,
a disperser,
slurry or solution and sorbent supply and discharge pipes,
a catchment located below the slurry level, wherein:
the catchment is made in the form of an immersed draining device with a tapered bottom and a drain pipe ensuring evacuation by gravity of slurry or solution from the sorption unit,
the disperser is made in the form of a perforated pipe, on the outer surface of which elastic elements are located inside the circulator and is connected to a pipe for the supply of compressed air.

2. The sorption unit according to claim 1, wherein the elastic elements of the disperser are made of rubber, thermoplastic or polyurethane elastomers, and are installed close to each other.

3. The sorption unit according to claim 1, wherein the drain pipe is inbuilt in a side surface of a cover of the immersed draining device.

4. The sorption unit according to claim 1, further comprising a device for monitoring the concentration of a sorbent in a working volume, made in the form of a container installed in an upper part of the body, and equipped with a measuring cylinder, shut-off valves and an airlift for supplying slurry or solution, and sorbent from a working area of the sorption unit.

5. The sorption unit according to claim 1, wherein a coil filled with a thermal medium is installed in a central part of the body to maintain a reaction temperature at a stage of sorption recovery from the solution or slurry to a central part of a working volume of the sorption unit, while the circulator is located in the central part of the body.

6. The sorption unit according to claim 5, wherein water or water vapour is used as a thermal agent.

7. The sorption unit according to claim 1, wherein an additional disperser is installed at the bottom of the body, the additional dispenser being operable-to restart the draining device when the draining device stops.

8. The sorption unit according to claim 1, further comprising a cylindrical body and an immersed cylindrical draining device, the bottom of which is made conical.

9. The sorption unit according to claim 7, wherein the additional disperser is configured to ensure the production of fine air bubbles and their uniform distribution in a working volume of the sorption unit, which leads to one and the same concentration of the sorbent in an entire working volume of the sorption unit, and also prevents holes of the additional disperser from clogging with slurry or solution and prevents slurry or solution from entering a compressed air supply pipeline connected to the pipe for the supply of compressed air.

10. The sorption unit according to claim 9, wherein the immersed cylindrical draining device is operable to exclude a strong collision of the sorbent and slurry with the surface of the drain pipe and to:
reduce the mechanical destruction of the sorbent, and
reduce the sticking of slurry or solution on a surface of the drain pipe.

11. The sorption unit according to claim 1, wherein ionite is used as the sorbent, the ionite comprising one of an ion-exchange resin, an inorganic ion-exchange sorbent, or an activated carbon.

12. The sorption unit according to claim 1, wherein both compressed air and a mixture of compressed air with other gases is supplied to the disperser located inside the circulator to intensify a sorption process of the sorption unit, the comprised air or the mixture of compressed air with other gases comprises one or more of carbon dioxide, sulphur dioxide, ammonia, and hydrogen sulphide.
